(19) United States
(12) Patent Application Publication
(10) Pub. No.: US 2026/0346298 A1
(43) Pub. Date: Nov. 5, 2026

(54) MOBILE QUICK ADHESIVE DISPENSING METHOD FOR WIND TURBINE BLADE MOULDED BY LARGE MOULD

(71) Applicant: GURIT TOOLING (TAICANG) CO., LTD., Suzhou (CN)

(72) Inventors: Binjiang CHEN, Los Angeles, CA (US); Xinggang JIN, Suzhou (CN)

(73) Assignee: GURIT TOOLING (TAICANG) CO., LTD., Suzhou (CN)

(21) Appl. No.: 18/993,008

(22) PCT Filed: Mar. 11, 2024
(86) PCT No.: PCT/CN2024/080948

§ 371 Date: Jan. 10, 2025

(30) Foreign Application Priority Data
Jan. 18, 2024 (CN) 202410073589.1

(51) Int. Cl. B05D 1/26; B05C 11/10; B29C 65/52; B29L 31/08

(52) U.S. Cl. CPC B05D 1/26; B05C 11/1036; B29C 65/524; B29L 2031/085

(57) ABSTRACT

Disclosed is a mobile quick adhesive dispensing method for a wind turbine blade moulded by a large mould, including the steps of installation, pre-inspection of high-capacity adhesive mixers, conveying of the high-capacity adhesive mixers, preparation for adhesive dispensing, adhesive dispensing, receding from a turning arm and landing of the high-capacity adhesive mixers. By the method, heavy-duty guided vehicles moving at a constant speed drive the high-capacity adhesive mixers to move at a constant speed, thereby achieving good consistency and small positional deviations of adhesive dispensing of the large wind turbine blade mould, and avoiding bonding defects of blades.

### CROSS-REFERENCE TO RELATED APPLICATIONS

This application is the U.S. national stage of International Application No. PCT/CN2024/080948 filed on 11 Mar. 2024 which designated the U.S. and claims priority to Chinese Application No. CN202410073589.1 filed on 18 Jan. 2024, the entire contents of each of which are hereby incorporated by reference.

### TECHNICAL FIELD

The present invention relates to the field of wind turbine blades, and particularly relates to a mobile quick adhesive dispensing method for a wind turbine blade moulded by a large mould.

### BACKGROUND

A series of new energy industries represented by the wind power industry face industry challenges in cycle time reduction and efficiency improvement, especially in the production of wind turbine blades. Manufactured wind turbine blades on the market have varying lengths, which have reached and exceeded 100 meters, and simultaneously, the volume of adhesives dispensed increases, thereby causing longer adhesive dispensing time and reduction of production efficiency and influencing the quality of products because of curing risks caused by too much time for adhesive dispensing in the blade making process.

In the prior art, wind turbine blades are bonded with adhesives in a fixed-point manner. Equipment conveys mixed adhesives onto paper boards or into basins according to the required weight, and workers transfer the adhesives to designated places manually. In this transport process, a great deal of manpower is consumed while the mixed adhesives may be cured to produce lots of solid wastes, which would have an adverse effect on the environment and cause a great loss of materials. In many cases, an adhesive dispensing procedure is not completed yet on part of areas of a wind turbine blade while some places the adhesives have been cured, thereby causing a reduction of production efficiency and extremely unstable quality of products. Besides, an adhesive dispensing system is separated from two sides of an adhesive dispensing head, thereby causing poor adhesive dispensing efficiency due to a lack of coordination between the adhesive dispensing system and the adhesive dispensing head in the adhesive dispensing process.

For example, an automatic positioning wind turbine blade adhesive dispensing device and adhesive dispensing method disclosed in CN 114289269 B, comprising positioning guide rails, a power driven moving platform and an adhesive dispensing tool arranged on the power driven moving platform and synchronously moving along with the power driven moving platform, the positioning guide rails are arranged on both sides of front and back edges of a main blade mould, installation positions of the positioning guide rails are determined based on a parting line of the front and back edges of the main blade mould as a positioning standard in conjunction with positioning data of webs in a blade so that the shape of the positioning guide rail on each side is the same as that of a stream line on one corresponding side of the blade; the adhesive dispensing tool, the power driven moving platform and the positioning guide rails in a specific shape are integrated into an automatic positioning wind turbine blade adhesive dispensing device, which can implement accurate positioning and adhesive dispensing, solve the problems of uneven manual adhesive dispensing effects and large positional deviation, eliminate bonding defects caused by positioning deviation and improve quality of products. At the same time, the device can implement synchronous and automated adhesive dispensing on bonding regions of webs on the front and back edges and improve operational efficiency. However, in the actual operation process, wind turbine blades have large sizes, and the volume of adhesives dispensed is large, so the adhesive supplementation process is complicated, and part of adhesive dispensed areas of the wind turbine blade has been cured while part of areas of the wind turbine blade are not coated with adhesives. Moreover, the structure is high in cost and not suitable for various types of mould.

For another example, a device and method for automatically positioning adhesive dispensing positions of a wind turbine blade in the adhesive dispensing process disclosed in the Chinese patent CN 115646764 A belong to the field of wind turbine blade adhesive dispensing technology. The device comprises a wall-mounted track, a cross beam, an adhesive dispensing device and a follow-up carrying trolley, the wall-mounted track is mounted on an I-beam of a stand column in a production workshop of a factory and is divided into an upper track and a lower track, the upper track and the lower track are respectively provided with an upper square tube and a lower square tube, and the upper square tube and the lower square tube together support a cross beam walking component; the cross beam comprises a cross beam main body and the cross beam walking component, and the cross beam walking component is connected to the cross beam main body through a rotating shaft; the cross beam provides supporting and guiding for the adhesive dispensing device; the adhesive dispensing device comprises a waling servo hoist, a balancer and a rubber boot and is suspended onto the cross beam main body; and the follow-up carrying trolley is used for carrying an adhesive dispensing system and control system hardware. The present invention can meet the demands of different adhesive dispensing areas of blades for adhesive dispensing processes and improve the adhesive dispensing operation efficiency and quality. The adhesive dispensing device in this structure is high in cost and not suitable for various types of mould, and also has a problem of low adhesive dispensing speeds, so the adhesive supplementation process is complicated, part of adhesive dispensed areas of a wind turbine blade have been cured while part of areas are not coated with adhesives, and the working efficiency is low.

### SUMMARY

The goal of the present invention is to solve deficiencies in the prior art, the present invention provides a mobile quick adhesive dispensing method for a wind turbine blade moulded by a large mould, and by this method, quick adhesive dispensing to large wind turbine blades can be realized, the adhesive dispensing process is accurate, and operation quality and efficiency are greatly improved.

The technical solution: to achieve the goal above, the mobile quick adhesive dispensing method for a wind turbine blade moulded by a large mould according to the present invention comprises the steps:
Step 1, installation
placing a plurality of high-capacity adhesive mixer rail systems between two halves of a large wind turbine blade mould, installing a screw lift at one end of the high-capacity adhesive mixer rail systems, installing a receding device between the two adjacent high-capacity adhesive mixer rail systems, and determining the number of high-capacity adhesive mixers to be placed on the high-capacity adhesive mixer rail systems according to the volume of adhesives dispensed to a wind turbine blade;
Step 2, pre-inspection of the high-capacity adhesive mixers conveying a heavy-duty guided vehicle loaded with a high-capacity adhesive mixer onto a guided vehicle bearing platform, starting a switching power supply of a center console, feeding, by a weight sensor on the guided vehicle bearing platform, data back to a PLC circuit after receiving a signal by the weight sensor, determining, by the PLC circuit, whether the volume of adhesives in the high-capacity adhesive mixer satisfies a limit value according to the feedback data of the weight sensor, if the data of the weight sensor satisfies the limit value, sending, by the PLC circuit, a switch-on signal to the center console, and if the data of the weight sensor does not satisfy the limit value, sending, by the PLC circuit, a warning signal to the center console;
Step 3, conveying of the high-capacity adhesive mixers
when the center console receives the switch-on signal sent by the PLC circuit, pressing, by an operator, an on button of the center console, sending, by the PLC circuit, signals to driving motors to allow the driving motors to rotate clockwise to drive self-locking screws connected thereto to rotate anticlockwise, so that the guided vehicle bearing platform horizontally and gradually moves upward to a specified position, sending, by position sensors located on frame mechanisms, signals to the PLC circuit, after the guided vehicle bearing platform moves upward to the specified position, sending, by the PLC circuit, rotating stop signals to the driving motors, sending, by the PLC circuit, a signal to a vehicle driving motor to drive the heavy-duty guided vehicle loaded with the high-capacity adhesive mixer to move on the high-capacity adhesive mixer rail system to the specified position;
Step 4, preparation for adhesive dispensing
repeating Step 3, conveying a plurality of heavy-duty guided vehicles loaded with high-capacity adhesive mixers to the specified positions on the high-capacity adhesive mixer rail systems in sequence, sending, by the PLC circuit, signals to the high-capacity adhesive mixers, adjusting positions of adhesive outlets of the high-capacity adhesive mixers by rotating to correspond to the position of the large wind turbine blade mould to prepare for adhesive dispensing;
Step 5, adhesive dispensing
sending, by the PLC circuit, signals to the vehicle driving motors and the high-capacity adhesive mixers, driving, by the heavy-duty guided vehicles, the high-capacity adhesive mixers to move back and forth on the high-capacity adhesive mixer rail systems at a constant speed, and dispensing, by the high-capacity adhesive mixers, adhesives uniformly to the large wind turbine blade mould, wherein the moving positions of the two adjacent heavy-duty guided vehicles are partially repeated;
Step 6, receding from a turning arm
when the turning arm is required to join the two halves of the large wind turbine blade mould, sending, by the PLC circuit, signals to the heavy-duty guided vehicle to allow the heavy-duty guided vehicle to move to an initial specified position, sending, by the PLC circuit, signals to air pumps to stop the air pumps from feeding gas into a left air cylinder and a right air cylinder, so that piston rods of the left air cylinder and the right air cylinder return to the insides of pistons, thereby allowing a Left receding mechanism and a Right receding mechanism to be disconnected under the action of the left air cylinder and the right air cylinder, wherein a disconnected distance between the Left receding mechanism and the Right receding mechanism is a width required for the turning of the turning arm;

When the turning arm completes the joining of the two halves of the large wind turbine blade mould, sending, by the PLC circuit, signals to the air pumps to allow the piston rods of the left air cylinder and the right air cylinder to be pushed out to push the Left receding mechanism and the Right receding mechanism upward respectively, so that the Left receding mechanism and the Right receding mechanism are respectively connected to the two adjacent high-capacity adhesive mixer rail systems to allow the heavy-duty guided vehicle loaded with the high-capacity adhesive mixer to go into a space between the Left receding mechanism and the Right receding mechanism from the high-capacity adhesive mixer rail system, subsequently go into the next high-capacity adhesive mixer rail system and finally arrive at the guided vehicle bearing platform located at one end of the frontmost high-capacity adhesive mixer rail system;
Step 7, landing of the high-capacity adhesive mixers
sending, by the PLC circuit, signals to the driving motors to allow the driving motors to rotate anticlockwise to drive the self-locking screws connected thereto to rotate clockwise, so that the guided vehicle bearing platform horizontally and gradually moves downward to a specified position, sending, by the position sensors located on the frame mechanisms, signals to the PLC circuit, when the guided vehicle bearing platform moves downward to the specified position, sending, by the PLC circuit, rotating stop signals to the driving motors to allow the heavy-duty guided vehicle to land on the ground, and repeating the above actions until all the heavy-duty guided vehicles land on the ground; and
Step 8, repeating
repeating Step 2 to Step 6 to complete the adhesive dispensing to a next blade to realize adhesive dispensing production of wind turbine blades in batches.

As a further preference of the present invention, in Step 3, the number of the high-capacity adhesive mixers distributed at a root portion of the large wind turbine blade mould accounts for 70%-75% of the total number of the high-capacity adhesive mixers.

As a further preference of the present invention, a length of a root portion of the large wind turbine blade mould accounts for 30%-40% of an overall length of the large wind turbine blade mould.

As a further preference of the present invention, in Step 4, the moving positions of the two adjacent heavy-duty guided vehicles are repeated by 10 cm-15 cm.

As a further preference of the present invention, in Step 4, an adhesive output volume of the high-capacity adhesive mixer is 10 L/min-20 L/min.

As a further preference of the present invention, two halves of the large wind turbine blade mould are arranged on both sides of the high-capacity adhesive mixer rail systems, and the receding device for receding from the turning arm is arranged between the two adjacent high-capacity adhesive mixer rail systems located in the straight line; because the turning arm is required to join and separate the two halves of the large wind turbine blade mould in the process of preparing a wind turbine blade, a width required for the turning of a turning mechanism is reserved on the high-capacity adhesive mixer rail systems so that the large wind turbine blade mould can be joined and separated without considering the influence of adhesive dispensing procedures, the receding devices can be opened in real time to allow the turning mechanism to be turned quickly, thereby improving production efficiency.

The screw lift is installed on the high-capacity adhesive mixer rail system located at one end of the large wind turbine blade mould. The heavy-duty guided vehicles loaded with the high-capacity adhesive mixers are conveyed onto the high-capacity adhesive mixer rail systems through the screw lift. When required, a plurality of high-capacity adhesive mixers are conveyed to specified positions on the high-capacity adhesive mixer rail systems through the screw lift in sequence.

As a further preference of the present invention, the screw lift comprises the guided vehicle bearing platform, the self-locking screws, the frame mechanisms, the driving motors, speed reducers, linear guide pillars and a base plate;

the two frame mechanisms arranged oppositely are respectively and perpendicularly installed on the base plate, the self-locking screws are fastened on the frame mechanisms, the linear guide pillars that are located on both sides of the self-locking screws and arranged parallel to the self-locking screws are fastened to the frame mechanisms respectively, both sides of the guided vehicle bearing platform horizontally installed above the base plate are respectively clamped onto the two opposite frame mechanisms, and output ends of the speed reducers secured on the base plate are connected to the self-locking screws; internal threads on the guided vehicle bearing platform are connected with external threads of the self-locking screws in a matched mode, and the linear guide pillars arranged oppositely are respectively clamped on side faces of the guided vehicle bearing platform; and the guided vehicle bearing platform moves up and down within the two frame mechanisms under rotation of the self-locking screws.

Since the two linear guide pillars and the self-locking screws are located in the same plane of the frame mechanisms and the two frame mechanisms are arranged oppositely, when receiving the signals of the PLC circuit and rotating simultaneously, the two driving motors rotate to drive the two self-locking screws to rotate, and both sides of the guided vehicle bearing platform are clamped to the linear guide pillars of the frame mechanisms, and at the moment, the two self-locking screws rotate to respectively drive the internal threads located on both sides of the guided vehicle bearing platform and connected with the self-locking screws in a matched mode to implement the horizontal movement of the guided vehicle bearing platform in a height direction.

As a further preference of the present invention, the two self-locking screws arranged oppositely are respectively fastened on the frame mechanisms, and both sides of the self-locking screws are each at least provided with a linear guide pillar.

As a further preference of the present invention, the heavy-duty guided vehicle comprises the vehicle driving motor, follower wheels, limit wheels and driving wheels which are all installed under a vehicle body, the vehicle driving motor is connected to the driving wheels, and the limit wheels fastened below the vehicle body are clamped in grooves in side faces of the high-capacity adhesive mixer rail system to limit the position of the heavy-duty guided vehicle relative to the high-capacity adhesive mixer rail system in a horizontal direction and a width direction.

Side faces of the high-capacity adhesive mixer rail system are provided with I-beams, and the follower wheels, and the limit wheels and the driving wheels are arranged in pairs; the limit wheels are clamped in grooves of the I-beams to guarantee stabilities of the heavy-duty guided vehicles in a horizontal direction and a perpendicular direction; the heavy-duty guided vehicles are trackless flat wagons purchased by the supplier Dongteng Intelligent Equipment Co. Ltd. Since operating modes and operating principles of the heavy-duty guided vehicles belong to the prior art and the heavy-duty guided vehicles have been widely used in the prior art, specific structures of the heavy-duty guided vehicles will not be illustrated again here.

As a further preference of the present invention, the receding device is hinged between the two adjacent high-capacity adhesive mixer rail systems, and the receding device comprises a Left receding mechanism and a Right receding mechanism which are respectively hinged to the high-capacity adhesive mixer rail systems through receding hinges, and a left air cylinder and a right air cylinder which are used for controlling the Left receding mechanism and the Right receding mechanism to be connected and disconnected, and the left air cylinder and the right air cylinder are respectively connected to air pumps.

As a further preference of the present invention, one end of the left air cylinder and one end of the right air cylinder are respectively hinged to supporting bases for supporting the high-capacity adhesive mixer rail system, and the other end of the left air cylinder and the other end of the right air cylinder are respectively hinged to the Left receding mechanism and the Right receding mechanism;
when the air pumps feed gas into the left air cylinder and the right air cylinder, the piston rods of the left air cylinder and the right air cylinder are pushed out to push the Left receding mechanism and the Right receding mechanism upward respectively, so that the Left receding mechanism and the Right receding mechanism are respectively connected to the two adjacent high-capacity adhesive mixer rail systems to allow the heavy-duty guided vehicle loaded with the high-capacity adhesive mixer to go into a space between the Left receding mechanism and the Right receding mechanism from the high-capacity adhesive mixer rail system and subsequently go into the next high-capacity adhesive mixer rail system;
When the air pumps stop feeding gas into the left air cylinder and right air cylinder, the piston rods of the left air cylinder and the right air cylinder return to their original positions to allow the Left receding mechanism and the Right receding mechanism to be disconnected under the action of the left air cylinder and the right air cylinder, and a disconnected distance between the Left receding mechanism and the Right receding mechanism is a width required for the turning of the turning arm.

As a further preference of the present invention, the total sum of lengths of the Left receding mechanism and the Right receding mechanism is equal to a distance between the two adjacent high-capacity adhesive mixer rail systems for supporting.

When the turning arm is required to join and separate the two halves of the large wind turbine blade mould, a width required for the turning of the turning mechanism is reserved on the high-capacity adhesive mixer rail systems so that the two halves of the large wind turbine blade mould can be joined and separated without considering the influence of adhesive dispensing procedures, and the receding devices can be opened in real time to allow the turning mechanism to be turned quickly.

The high-capacity adhesive mixers mounted on the heavy-duty guided vehicles are driven by the heavy-duty guided vehicles to move back and forth on the high-capacity adhesive mixer rail systems and uniformly dispense adhesives onto the large wind turbine blade mould through adhesive outlets of the high-capacity adhesive mixers, and a coating density of the adhesives is set according to the requirements of different wind turbine blades. The high-capacity adhesive mixers in the technical solution are purchased from the supplier DOPAG, and the model is gelcomlx. Since operating modes and operating principles of the high-capacity adhesive mixers belong to the prior art and the high-capacity adhesive mixers have been widely used in the prior art, specific structures of the high-capacity adhesive mixers will not be illustrated again here.

As a further preference of the present invention, the driving motors, the vehicle driving motors and the air pumps are connected to the PLC circuit respectively.

Beneficial effect: compared with the prior art, the mobile quick adhesive dispensing method for a wind turbine blade moulded by a large mould according to the present invention has the following advantages:
(1) the heavy-duty guided vehicles moving at a constant speed drive the high-capacity adhesive mixers to move at a constant speed, thereby achieving good consistency and small positional deviations of adhesive dispensing of the large wind turbine blade mould, and avoiding bonding defects of blades.
(2) through the cooperation of a plurality of high-capacity adhesive mixers and the receding devices, the adhesive dispensing to the large wind turbine blades can be completed within 30 min, thereby preventing a situation that part of adhesive dispensed areas have been cured while part of areas are not coated with adhesives because the large wind turbine blade mould is too large;
(3) the moving positions of the two adjacent heavy-duty guided vehicles are partially repeated, thereby preventing part of structures from being omitted and not coated with adhesives;
(4) the plurality of high-capacity adhesive mixers move leftward or rightward simultaneously, thereby ensuring that no interferences and collisions occur to the high-capacity adhesive mixers in the adhesive dispensing process, optimizing adhesive dispensing paths, realizing the quick and accurate adhesive dispensing process and greatly improving operation quality and efficiency; and
(5) the adhesive dispensing is completed quickly and efficiently through the automatic control of the PLC circuit on the screw lift, the heavy-duty guided vehicles, the high-capacity adhesive mixers and the receding devices, thereby realizing automated adhesive dispensing production of wind turbine blades in batches.

### BRIEF DESCRIPTION OF THE DRAWINGS

FIG. 1 is a structural schematic view of a state of preparation for adhesive dispensing according to the present invention;

FIG. 2 is a structural schematic view of implementing lifting according to the present invention;

FIG. 3 is a structural schematic view of a state of adhesive dispensing according to the present invention;

FIG. 4 is a structural schematic view of a heavy-duty guided vehicle;

FIG. 5 is a structural schematic view of a receding device of a turning mechanism;

FIG. 6 is a structural schematic view of a screw lift.

### DETAILED DESCRIPTION OF EMBODIMENTS

The present invention will be further described in combination with the accompanying drawings and the specific embodiments.

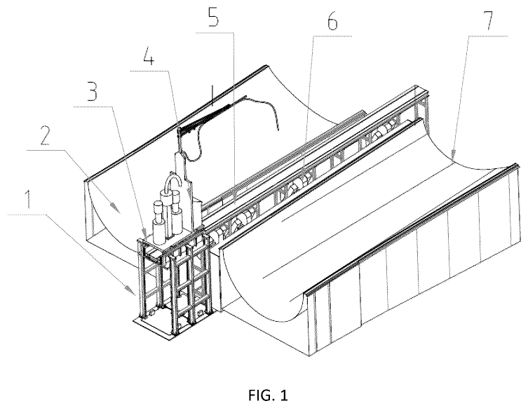

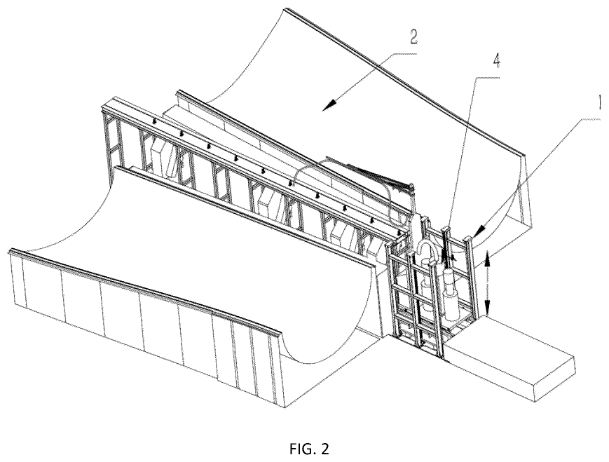

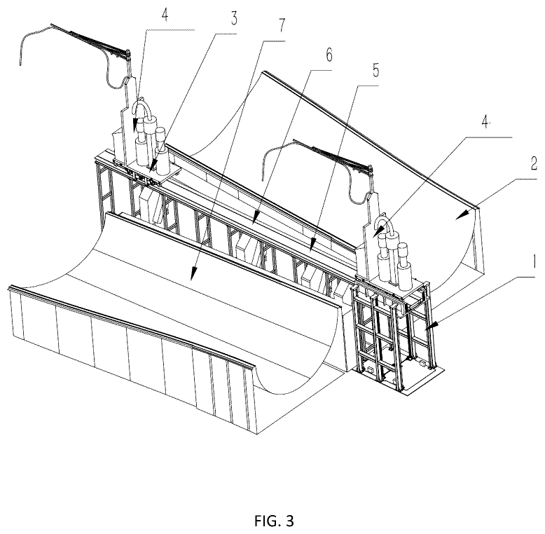

As shown in FIG. 1, FIG. 2 and FIG. 3, a mobile quick adhesive dispensing method for a wind turbine blade moulded by a large mould, includes the steps of installation, pre-inspection of high-capacity adhesive mixers, conveying of the high-capacity adhesive mixers, preparation for adhesive dispensing, adhesive dispensing, receding from a turning arm and landing of the high-capacity adhesive mixers.

### Embodiment 1

Step 1, placing a plurality of high-capacity adhesive mixer rail systems 5 between two halves of a large wind turbine blade mould 2, installing a screw lift 1 at one end of the high-capacity adhesive mixer rail systems 5, installing a receding device 6 between the two adjacent high-capacity adhesive mixer rail systems 5, and determining the number of high-capacity adhesive mixers 4 to be placed on the high-capacity adhesive mixer rail systems 5 according to the volume of adhesives dispensed to a wind turbine blade;

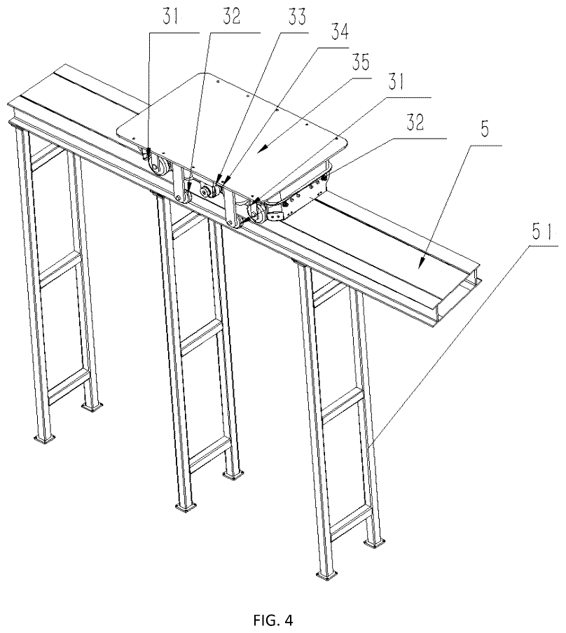

A vehicle driving motor 34, follower wheels 31, limit wheels 32 and driving wheels 33 are installed below a vehicle body 35, the vehicle driving motor 34 is connected to the driving wheels 33, and the limit wheels 32 fastened below the vehicle body 35 are clamped in grooves in side faces of the high-capacity adhesive mixer rail system 5 to limit the position of the heavy-duty guided vehicle 3 relative to the high-capacity adhesive mixer rail system 5 in a horizontal direction and a width direction, as shown in FIG. 4.

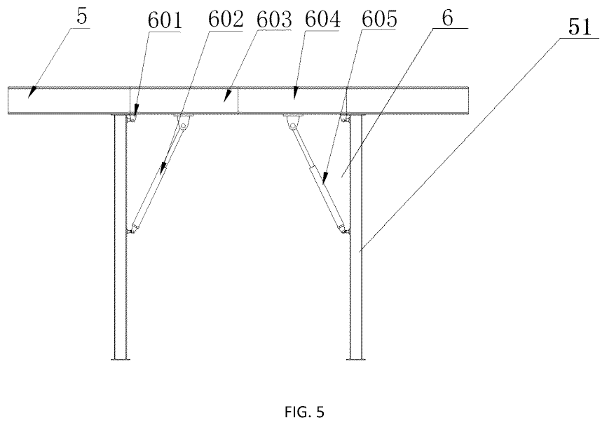

A left air cylinder 602 and a right air cylinder 605 are respectively connected to air pumps, a Left receding mechanism 603 and a Right receding mechanism 604 are respectively hinged to the high-capacity adhesive mixer rail systems 5 through receding hinges 601, the left air cylinder 602 and the right air cylinder 605 are used for controlling the Left receding mechanism 603 and the Right receding mechanism 604 to be connected and disconnected, and a disconnected size between the Left receding mechanism 603 and the Right receding mechanism 604 is a reserved spatial size required by a turning arm to turn the large wind turbine blade mould 2, as shown in FIG. 5.

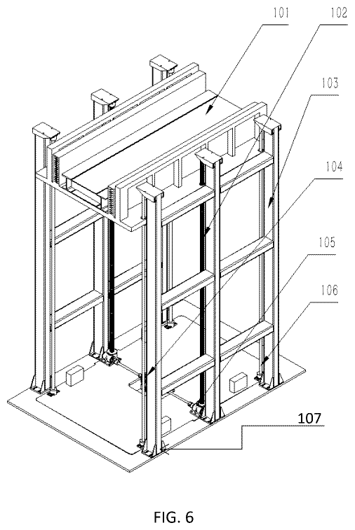

Two frame mechanisms 103 arranged oppositely are respectively and perpendicularly installed on a base plate 107, self-locking screws 102 are fastened on the frame mechanisms 103, linear guide pillars 106 that are located on both sides of the self-locking screws 102 and arranged parallel to the self-locking screws 102 are fastened to the frame mechanisms 103 respectively, both sides of a guided vehicle bearing platform 101 horizontally installed above the base plate 107 are respectively clamped onto the two opposite frame mechanisms 103, output ends of speed reducers 105 secured on the base plate 107 are connected to the self-locking screws 102, the guided vehicle bearing platform 101 moves up and down within the two frame mechanisms 103 under rotation of the self-locking screws 102 to convey a plurality of heavy-duty guided vehicles 3 loaded with the high-capacity adhesive mixers 4 into the high-capacity adhesive mixer rail systems 5 in sequence in a lifting mode, as shown in FIG. 6.
Step 2, conveying the heavy-duty guided vehicle 3 loaded with the high-capacity adhesive mixer 4 onto the guided vehicle bearing platform 101, starting a switching power supply of a center console, feeding, by a weight sensor on the guided vehicle bearing platform 101, data back to a PLC circuit after receiving a signal by the weight sensor, determining, by the PLC circuit, whether the volume of adhesives in the high-capacity adhesive mixer 4 satisfies a limit value according to the feedback data of the weight sensor, if the data of the weight sensor satisfies the limit value, sending, by the PLC circuit, a switch-on signal to the center console, and if the data of the weight sensor does not satisfy the limit value, sending, by the PLC circuit, a warning signal to the center console;
Step 3, when the center console receives the switch-on signal sent by the PLC circuit, pressing, by an operator, an on button of the center console, sending, by the PLC circuit, signals to driving motors 104 to allow the driving motors 104 to rotate clockwise to drive the self-locking screws 102 connected thereto to rotate anticlockwise, so that the guided vehicle bearing platform 101 horizontally and gradually moves upward to a specified position, sending, by position sensors located on the frame mechanisms 103, signals to the PLC circuit, after the guided vehicle bearing platform 101 moves upward to the specified position, sending, by the PLC circuit, rotating stop signals to the driving motors 104, sending, by the PLC circuit, a signal to the vehicle driving motor 34 to drive the heavy-duty guided vehicle 3 loaded with the high-capacity adhesive mixer 4 to move on the high-capacity adhesive mixer rail system 5 to the specified position;
Step 4, repeating Step 3, conveying a plurality of heavy-duty guided vehicles 3 loaded with the high-capacity adhesive mixers 4 to the specified positions on the high-capacity adhesive mixer rail systems 5 in sequence, sending, by the PLC circuit, signals to the high-capacity adhesive mixers 4, adjusting positions of adhesive outlets of the high-capacity adhesive mixers 4 by rotating to correspond to the position of the large wind turbine blade mould 2 to prepare for adhesive dispensing, wherein the number of the high-capacity adhesive mixers 4 distributed at a root portion of the large wind turbine blade mould 2 accounts for 70% of the total number of the high-capacity adhesive mixers 4, and a length of the root portion of the large wind turbine blade mould 2 accounts for 30% of an overall length of the large wind turbine blade mould 2;
Step 5, sending, by the PLC circuit, signals to the vehicle driving motors 34 and the high-capacity adhesive mixers 4, driving, by the heavy-duty guided vehicles 3, the high-capacity adhesive mixers 4 to move back and forth on the high-capacity adhesive mixer rail systems 5 at a constant speed, and dispensing, by the high-capacity adhesive mixers 4, adhesives uniformly to the large wind turbine blade mould 2 to obtain adhesive dispensing paths 7 distributed uniformly, wherein the moving positions of the two adjacent heavy-duty guided vehicles 3 are repeated by 10 cm, and an adhesive output volume of the high-capacity adhesive mixer 4 is 10 L/min;
Step 6, when the turning arm is required to join the two halves of the large wind turbine blade mould 2, sending, by the PLC circuit, a signal to the heavy-duty guided vehicle 3 to allow the heavy-duty guided vehicle 3 to move to an initial specified position, sending, by the PLC circuit, signals to the air pumps to stop the air pumps from feeding gas into the left air cylinder 602 and the right air cylinder 605, so that piston rods of the left air cylinder 602 and the right air cylinder 605 return to the insides of pistons, thereby allowing the Left receding mechanism 603 and the Right receding mechanism 604 to be disconnected under the action of the left air cylinder 602 and the right air cylinder 605, wherein a disconnected distance between the Left receding mechanism 603 and the Right receding mechanism 604 is a width required for the turning of the turning arm;
when the turning arm completes the joining of the two halves of the large wind turbine blade mould 2, sending, by the PLC circuit, signals to the air pumps to allow the piston rods of the left air cylinder 602 and the right air cylinder 605 to be pushed out to push the Left receding mechanism 603 and the Right receding mechanism 604 upward respectively, so that the Left receding mechanism 603 and the Right receding mechanism 604 are respectively connected to the two adjacent high-capacity adhesive mixer rail systems 5 to allow the heavy-duty guided vehicle 3 loaded with the high-capacity adhesive mixer 4 to go into a space between the Left receding mechanism 603 and the Right receding mechanism 604 from the high-capacity adhesive mixer rail system 5, subsequently go into the next high-capacity adhesive mixer rail system 5 and finally arrive at the guided vehicle bearing platform 101 located at one end of the frontmost high-capacity adhesive mixer rail system 5;
Step 7, sending, by the PLC circuit, signals to the driving motors 104 to allow the driving motors 104 to rotate anticlockwise to drive the self-locking screws 102 connected thereto to rotate clockwise, so that the guided vehicle bearing platform 101 horizontally and gradually moves downward to a specified position, sending, by the position sensors located on the frame mechanisms 103, signals to the PLC circuit, when the guided vehicle bearing platform 101 moves downward to the specified position, sending, by the PLC circuit, rotating stop signals to the driving motors 104 to allow the heavy-duty guided vehicle 3 to land on the ground, and repeating the above actions until all the heavy-duty guided vehicles 3 land on the ground; and
Step 8, repeating Step 2 to Step 6 to complete the adhesive dispensing to a next blade to realize adhesive dispensing production of wind turbine blades in batches.

### Embodiment 2

Step 1, placing a plurality of high-capacity adhesive mixer rail systems 5 between two halves of a large wind turbine blade mould 2, installing a screw lift 1 at one end of the high-capacity adhesive mixer rail systems 5, installing a receding device 6 between the two adjacent high-capacity adhesive mixer rail systems 5, and determining the number of high-capacity adhesive mixers 4 to be placed on the high-capacity adhesive mixer rail system 5 according to the volume of adhesives dispensed to a wind turbine blade;
A vehicle driving motor 34, follower wheels 31, limit wheels 32 and driving wheels 33 are installed below a vehicle body 35, the vehicle driving motor 34 is connected to the driving wheels 33, and the limit wheels 32 fastened below the vehicle body 35 are clamped in grooves in side faces of the high-capacity adhesive mixer rail system 5 to limit the position of the heavy-duty guided vehicle 3 relative to the high-capacity adhesive mixer rail system 5 in a horizontal direction and a width direction, as shown in FIG. 4.

A left air cylinder 602 and a right air cylinder 605 are respectively connected to air pumps, a Left receding mechanism 603 and a Right receding mechanism 604 are respectively hinged to the high-capacity adhesive mixer rail systems 5 through receding hinges 601, the left air cylinder 602 and the right air cylinder 605 are used for controlling the Left receding mechanism 603 and the Right receding mechanism 604 to be connected and disconnected, and a disconnected size between the Left receding mechanism 603 and the Right receding mechanism 604 is a reserved spatial size required by a turning arm to turn the large wind turbine blade mould 2, as shown in FIG. 5.

Two frame mechanisms 103 arranged oppositely are respectively and perpendicularly installed on a base plate 107, self-locking screws 102 are fastened on the frame mechanisms 103, linear guide pillars 106 that are located on both sides of the self-locking screws 102 and arranged parallel to the self-locking screws 102 are fastened to the frame mechanisms 103 respectively, both sides of a guided vehicle bearing platform 101 horizontally installed above the base plate 107 are respectively clamped onto the two opposite frame mechanisms 103, output ends of speed reducers 105 secured on the base plate 107 are connected to the self-locking screws 102, the guided vehicle bearing platform 101 moves up and down within the two frame mechanisms 103 under rotation of the self-locking screws 102 to convey a plurality of heavy-duty guided vehicles 3 loaded with the high-capacity adhesive mixers 4 into the high-capacity adhesive mixer rail systems 5 in sequence in a lifting mode, as shown in FIG. 6.
Step 2, conveying the heavy-duty guided vehicle 3 loaded with the high-capacity adhesive mixer 4 onto the guided vehicle bearing platform 101, starting a switching power supply of a center console, feeding, by a weight sensor on the guided vehicle bearing platform 101, data back to a PLC circuit after receiving a signal by the weight sensor, determining, by the PLC circuit, whether the volume of adhesives in the high-capacity adhesive mixer 4 satisfies a limit value according to the feedback data of the weight sensor, if the data of the weight sensor satisfies the limit value, sending, by the PLC circuit, a switch-on signal to the center console, and if the data of the weight sensor does not satisfy the limit value, sending, by the PLC circuit, a warning signal to the center console;
Step 3, when the center console receives the switch-on signal sent by the PLC circuit, pressing, by an operator, an on button of the center console, sending, by the PLC circuit, signals to driving motors 104 to allow the driving motors 104 to rotate clockwise to drive the self-locking screws 102 connected thereto to rotate anticlockwise, so that the guided vehicle bearing platform 101 horizontally and gradually moves upward to a specified position, sending, by position sensors located on the frame mechanisms 103, signals to the PLC circuit, after the guided vehicle bearing platform 101 moves upward to the specified position, sending, by the PLC circuit, rotating stop signals to the driving motors 104, sending, by the PLC circuit, a signal to the vehicle driving motor 34 to drive the heavy-duty guided vehicle 3 loaded with the high-capacity adhesive mixer 4 to move on the high-capacity adhesive mixer rail system 5 to the specified position;
Step 4, repeating Step 3, conveying a plurality of heavy-duty guided vehicles 3 loaded with the high-capacity adhesive mixers 4 to the specified positions on the high-capacity adhesive mixer rail systems 5 in sequence, sending, by the PLC circuit, signals to the high-capacity adhesive mixers 4, adjusting positions of adhesive outlets of the high-capacity adhesive mixers 4 by rotating to correspond to the position of the large wind turbine blade mould 2 to prepare for adhesive dispensing, wherein the number of the high-capacity adhesive mixers 4 distributed at a root portion of the large wind turbine blade mould 2 accounts for 72% of the total number of the high-capacity adhesive mixers 4, and a length of the root portion of the large wind turbine blade mould 2 accounts for 35% of an overall length of the large wind turbine blade mould 2;
Step 5, sending, by the PLC circuit, signals to the vehicle driving motors 34 and the high-capacity adhesive mixers 4, driving, by the heavy-duty guided vehicles 3, the high-capacity adhesive mixers 4 to move back and forth on the high-capacity adhesive mixer rail systems 5 at a constant speed, and dispensing, by the high-capacity adhesive mixers 4, adhesives uniformly to the large wind turbine blade mould 2 to obtain adhesive dispensing paths 7 distributed uniformly, wherein the moving positions of the two adjacent heavy-duty guided vehicles 3 are repeated by 13 cm, and an adhesive output volume of the high-capacity adhesive mixer 4 is 16 L/min;
Step 6, when the turning arm is required to join the two halves of the large wind turbine blade mould 2, sending, by the PLC circuit, a signal to the heavy-duty guided vehicle 3 to allow the heavy-duty guided vehicle 3 to move to an initial specified position, sending, by the PLC circuit, signals to the air pumps to stop the air pumps from feeding gas into the left air cylinder 602 and the right air cylinder 605, so that piston rods of the left air cylinder 602 and the right air cylinder 605 return to the insides of pistons, thereby allowing the Left receding mechanism 603 and the Right receding mechanism 604 to be disconnected under the action of the left air cylinder 602 and the right air cylinder 605, wherein a disconnected distance between the Left receding mechanism 603 and the Right receding mechanism 604 is a width required for the turning of the turning arm; when the turning arm completes the joining of the two halves of the large wind turbine blade mould 2, sending, by the PLC circuit, signals to the air pumps to allow the piston rods of the left air cylinder 602 and the right air cylinder 605 to be pushed out to push the Left receding mechanism 603 and the Right receding mechanism 604 upward respectively, so that the Left receding mechanism 603 and the Right receding mechanism 604 are respectively connected to the two adjacent high-capacity adhesive mixer rail systems 5 to allow the heavy-duty guided vehicle 3 loaded with the high-capacity adhesive mixer 4 to go into a space between the Left receding mechanism 603 and the Right receding mechanism 604 from the high-capacity adhesive mixer rail system 5, subsequently go into the next high-capacity adhesive mixer rail system 5 and finally arrive at the guided vehicle bearing platform 101 located at one end of the frontmost high-capacity adhesive mixer rail system 5;
Step 7, sending, by the PLC circuit, signals to the driving motors 104 to allow the driving motors 104 to rotate anticlockwise to drive the self-locking screws 102 connected thereto to rotate clockwise, so that the guided vehicle bearing platform 101 horizontally and gradually moves downward to a specified position, sending, by the position sensors located on the frame mechanisms 103, signals to the PLC circuit, when the guided vehicle bearing platform 101 moves downward to the specified position, sending, by the PLC circuit, rotating stop signals to the driving motors 104 to allow the heavy-duty guided vehicle 3 to land on the ground, and repeating the above actions until all the heavy-duty guided vehicles 3 land on the ground; and
Step 8, repeating Step 2 to Step 6 to complete the adhesive dispensing to a next blade to realize adhesive dispensing production of wind turbine blades in batches.

### Embodiment 3

Step 1, placing a plurality of high-capacity adhesive mixer rail systems 5 between two halves of a large wind turbine blade mould 2, installing a screw lift 1 at one end of the high-capacity adhesive mixer rail systems 5, installing a receding device 6 between the two adjacent high-capacity adhesive mixer rail systems 5, and determining the number of high-capacity adhesive mixers 4 to be placed on the high-capacity adhesive mixer rail systems 5 according to the volume of adhesives dispensed to a wind turbine blade;
A vehicle driving motor 34, follower wheels 31, limit wheels 32 and driving wheels 33 are installed below a vehicle body 35, the vehicle driving motor 34 is connected to the driving wheels 33, and the limit wheels 32 fastened below the vehicle body 35 are clamped in grooves in side faces of the high-capacity adhesive mixer rail system 5 to limit the position of the heavy-duty guided vehicle 3 relative to the high-capacity adhesive mixer rail system 5 in a horizontal direction and a width direction, as shown in FIG. 4.

A left air cylinder 602 and a right air cylinder 605 are respectively connected to air pumps, a Left receding mechanism 603 and a Right receding mechanism 604 are respectively hinged to the high-capacity adhesive mixer rail systems 5 through receding hinges 601, the left air cylinder 602 and the right air cylinder 605 are used for controlling the Left receding mechanism 603 and the Right receding mechanism 604 to be connected and disconnected, and a disconnected size between the Left receding mechanism 603 and the Right receding mechanism 604 is a reserved spatial size required by a turning arm to turn the large wind turbine blade mould 2, as shown in FIG. 5.

Two frame mechanisms 103 arranged oppositely are respectively and perpendicularly installed on a base plate 107, self-locking screws 102 are fastened on the frame mechanisms 103, linear guide pillars 106 that are located on both sides of the self-locking screws 102 and arranged parallel to the self-locking screws 102 are fastened to the frame mechanisms 103 respectively, both sides of a guided vehicle bearing platform 101 horizontally installed above the base plate 107 are respectively clamped onto the two opposite frame mechanisms 103, output ends of speed reducers 105 secured on the base plate 107 are connected to the self-locking screws 102, the guided vehicle bearing platform 101 moves up and down within the two frame mechanisms 103 under rotation of the self-locking screws 102 to convey a plurality of heavy-duty guided vehicles 3 loaded with the high-capacity adhesive mixers 4 into the high-capacity adhesive mixer rail systems 5 in sequence in a lifting mode, as shown in FIG. 6.
Step 2, conveying the heavy-duty guided vehicle 3 loaded with the high-capacity adhesive mixer 4 onto the guided vehicle bearing platform 101, starting a switching power supply of a center console, feeding, by a weight sensor on the guided vehicle bearing platform 101, data back to a PLC circuit after receiving a signal by the weight sensor, determining, by the PLC circuit, whether the volume of adhesives in the high-capacity adhesive mixer 4 satisfies a limit value according to the feedback data of the weight sensor, if the data of the weight sensor satisfies the limit value, sending, by the PLC circuit, a switch-on signal to the center console, and if the data of the weight sensor does not satisfy the limit value, sending, by the PLC circuit, a warning signal to the center console;
Step 3, when the center console receives the switch-on signal sent by the PLC circuit, pressing, by an operator, an on button of the center console, sending, by the PLC circuit, signals to driving motors 104 to allow the driving motors 104 to rotate clockwise to drive the self-locking screws 102 connected thereto to rotate anticlockwise, so that the guided vehicle bearing platform 101 horizontally and gradually moves upward to a specified position, sending, by position sensors located on the frame mechanisms 103, signals to the PLC circuit, after the guided vehicle bearing platform 101 moves upward to the specified position, sending, by the PLC circuit, rotating stop signals to the driving motors 104, sending, by the PLC circuit, a signal to the vehicle driving motor 34 to drive the heavy-duty guided vehicle 3 loaded with the high-capacity adhesive mixer 4 to move on the high-capacity adhesive mixer rail system 5 to the specified position;
Step 4, repeating Step 3, conveying a plurality of heavy-duty guided vehicles 3 loaded with the high-capacity adhesive mixers 4 to the specified positions on the high-capacity adhesive mixer rail systems 5 in sequence, sending, by the PLC circuit, signals to the high-capacity adhesive mixers 4, adjusting positions of adhesive outlets of the high-capacity adhesive mixers 4 by rotating to correspond to the position of the large wind turbine blade mould 2 to prepare for adhesive dispensing, wherein the number of the high-capacity adhesive mixers 4 distributed at a root portion of the large wind turbine blade mould 2 accounts for 75% of the total number of the high-capacity adhesive mixers 4, and a length of the root portion of the large wind turbine blade mould 2 accounts for 40% of an overall length of the large wind turbine blade mould 2;
Step 5, sending, by the PLC circuit, signals to the vehicle driving motors 34 and the high-capacity adhesive mixers 4, driving, by the heavy-duty guided vehicles 3, the high-capacity adhesive mixers 4 to move back and forth on the high-capacity adhesive mixer rail systems 5 at a constant speed, and dispensing, by the high-capacity adhesive mixers 4, adhesives uniformly to the large wind turbine blade mould 2 to obtain adhesive dispensing paths 7 distributed uniformly, wherein the moving positions of the two adjacent heavy-duty guided vehicles 3 are repeated by 15 cm, and an adhesive output volume of the high-capacity adhesive mixer 4 is 20 L/min;
Step 6, when the turning arm is required to join the two halves of the large wind turbine blade mould 2, sending, by the PLC circuit, a signal to the heavy-duty guided vehicle 3 to allow the heavy-duty guided vehicle 3 to move to an initial specified position, sending, by the PLC circuit, signals to the air pumps to stop the air pumps from feeding gas into the left air cylinder 602 and the right air cylinder 605, so that piston rods of the left air cylinder 602 and the right air cylinder 605 return to the insides of pistons, thereby allowing the Left receding mechanism 603 and the Right receding mechanism 604 to be disconnected under the action of the left air cylinder 602 and the right air cylinder 605, wherein a disconnected distance between the Left receding mechanism 603 and the Right receding mechanism 604 is a width required for the turning of the turning arm;
when the turning arm completes the joining of the two halves of the large wind turbine blade mould 2, sending, by the PLC circuit, signals to the air pumps to allow the piston rods of the left air cylinder 602 and the right air cylinder 605 to be pushed out to push the Left receding mechanism 603 and the Right receding mechanism 604 upward respectively, so that the Left receding mechanism 603 and the Right receding mechanism 604 are respectively connected to the two adjacent high-capacity adhesive mixer rail systems 5 to allow the heavy-duty guided vehicle 3 loaded with the high-capacity adhesive mixer 4 to go into a space between the Left receding mechanism 603 and the Right receding mechanism 604 from the high-capacity adhesive mixer rail system 5, subsequently go into the next high-capacity adhesive mixer rail system 5 and finally arrive at the guided vehicle bearing platform 101 located at one end of the frontmost high-capacity adhesive mixer rail system 5;
Step 7, sending, by the PLC circuit, signals to the driving motors 104 to allow the driving motors 104 to rotate anticlockwise to drive the self-locking screws 102 connected thereto to rotate clockwise, so that the guided vehicle bearing platform 101 horizontally and gradually moves downward to a specified position, sending, by the position sensors located on the frame mechanisms 103, signals to the PLC circuit, when the guided vehicle bearing platform 101 moves downward to the specified position, sending, by the PLC circuit, rotating stop signals to the driving motors 104 to allow the heavy-duty guided vehicle 3 to land on the ground, and repeating the above actions until all the heavy-duty guided vehicles 3 land on the ground; and
Step 8, repeating Step 2 to Step 6 to complete the adhesive dispensing to a next blade to realize adhesive dispensing production of wind turbine blades in batches.

The above-mentioned implementations are only used to illustrate technical ideas and characteristics of the present invention so that any person skilled in the art can understand the content of the present invention and implement the content accordingly, but are not intended to limit the protection scope of the present invention. Any equivalent replacement or modification made within the spirit of the present invention should be included in the protection scope of the present invention.

What is claimed is:

1. A mobile quick adhesive dispensing method for a wind turbine blade moulded by a large mould, comprising the specific steps:
Step 1, installation
placing a plurality of high-capacity adhesive mixer rail systems (5) between two halves of a large wind turbine blade mould (2), installing a screw lift (1) at one end of the high-capacity adhesive mixer rail systems (5), installing a receding device (6) between the two adjacent high-capacity adhesive mixer rail systems (5), and determining the number of high-capacity adhesive mixers (4) to be placed on the high-capacity adhesive mixer rail systems (5) according to the volume of adhesives dispensed to a wind turbine blade;
Step 2, pre-inspection of the high-capacity adhesive mixers
conveying a heavy-duty guided vehicle (3) loaded with a high-capacity adhesive mixer (4) onto an guided vehicle bearing platform (101), starting a switching power supply of a center console, feeding, by a weight sensor on the guided vehicle bearing platform (101), data back to a PLC circuit after receiving a signal by the weight sensor, determining, by the PLC circuit, whether the volume of adhesives in the high-capacity adhesive mixer (4) satisfies a limit value according to the feedback data of the weight sensor, if the data of the weight sensor satisfies the limit value, sending, by the PLC circuit, a switch-on signal to the center console, and if the data of the weight sensor does not satisfy the limit value, sending, by the PLC circuit, a warning signal to the center console;
Step 3, conveying of the high-capacity adhesive mixers
when the center console receives the switch-on signal sent by the PLC circuit, pressing, by an operator, an on button of the center console, sending, by the PLC circuit, signals to driving motors (104) to allow the driving motors (104) to rotate clockwise to drive self-locking screws (102) connected thereto to rotate anticlockwise, so that the guided vehicle bearing platform (101) horizontally and gradually moves upward to a specified position, sending, by position sensors located on frame mechanisms (103), signals to the PLC circuit, after the guided vehicle bearing platform (101) moves upward to the specified position, sending, by the PLC circuit, rotating stop signals to the driving motors (104), sending, by the PLC circuit, a signal to a vehicle driving motor (34) to drive the heavy-duty guided vehicle (3) loaded with the high-capacity adhesive mixer (4) to move on the high-capacity adhesive mixer rail system (5) to the specified position;
Step 4, preparation for adhesive dispensing
repeating Step 3, conveying a plurality of heavy-duty guided vehicles (3) loaded with high-capacity adhesive mixers (4) to the specified positions on the high-capacity adhesive mixer rail systems (5) in sequence, sending, by the PLC circuit, signals to the high-capacity adhesive mixers (4), adjusting positions of adhesive outlets of the high-capacity adhesive mixers (4) by rotating to correspond to the position of the large wind turbine blade mould (2) to prepare for adhesive dispensing;
Step 5, adhesive dispensing
sending, by the PLC circuit, signals to the vehicle driving motors (34) and the high-capacity adhesive mixers (4), driving, by the heavy-duty guided vehicles (3), the high-capacity adhesive mixers (4) to move back and forth on the high-capacity adhesive mixer rail systems (5) at a constant speed, and dispensing, by the high-capacity adhesive mixers (4), adhesives uniformly to the large wind turbine blade mould (2), wherein the moving positions of the two adjacent heavy-duty guided vehicles (3) are partially repeated;
Step 6, receding from a turning arm
when the turning arm is required to join the two halves of the large wind turbine blade mould (2), sending, by the PLC circuit, a signal to the heavy-duty guided vehicle (3) to allow the heavy-duty guided vehicle (3) to move to an initial specified position, sending, by the PLC circuit, signals to air pumps to stop the air pumps from feeding gas into a left air cylinder (602) and a right air cylinder (605), so that piston rods of the left air cylinder (602) and the right air cylinder (605) return to the insides of pistons, thereby allowing a Left receding mechanism (603) and a Right receding mechanism (604) to be disconnected under the action of the left air cylinder (602) and the right air cylinder (605), wherein a disconnected distance between the Left receding mechanism (603) and the Right receding mechanism (604) is a width required for the turning of the turning arm;
when the turning arm completes the joining of the two halves of the large wind turbine blade mould (2), sending, by the PLC circuit, signals to the air pumps to allow the piston rods of the left air cylinder (602) and the right air cylinder (605) to be pushed out to push the Left receding mechanism (603) and the Right receding mechanism (604) upward respectively, so that the Left receding mechanism (603) and the Right receding mechanism (604) are respectively connected to the two adjacent high-capacity adhesive mixer rail systems (5) to allow the heavy-duty guided vehicle (3) loaded with the high-capacity adhesive mixer (4) to go into a space between the Left receding mechanism (603) and the Right receding mechanism (604) from the high-capacity adhesive mixer rail system (5), subsequently go into the next high-capacity adhesive mixer rail system (5) and finally arrive at the guided vehicle bearing platform (101) located at one end of the frontmost high-capacity adhesive mixer rail system (5);
Step 7, landing of the high-capacity adhesive mixers
sending, by the PLC circuit, signals to the driving motors (104) to allow the driving motors (104) to rotate anticlockwise to drive the self-locking screws (102) connected thereto to rotate clockwise, so that the guided vehicle bearing platform (101) horizontally and gradually moves downward to a specified position, sending, by the position sensors located on the frame mechanisms (103), signals to the PLC circuit, when the guided vehicle bearing platform (101) moves downward to the specified position, sending, by the PLC circuit, rotating stop signals to the driving motors (104) to allow the heavy-duty guided vehicle (3) to land on the ground, and repeating the above actions until all the heavy-duty guided vehicles (3) land on the ground; and
Step 8, repeating
repeating Step 2 to Step 6 to complete the adhesive dispensing to a next blade to realize adhesive dispensing production of wind turbine blades in batches.

2. The mobile quick adhesive dispensing method for a wind turbine blade moulded by a large mould according to claim 1, wherein in Step 3, the number of the high-capacity adhesive mixers (4) distributed at a root portion of the large wind turbine blade mould (2) accounts for 70%-75% of the total number of the high-capacity adhesive mixers (4).

3. The mobile quick adhesive dispensing method for a wind turbine blade moulded by a large mould according to claim 2, wherein a length of the root portion of the large wind turbine blade mould (2) accounts for 30%-40% of an overall length of the large wind turbine blade mould (2).

4. The mobile quick adhesive dispensing method for a wind turbine blade moulded by a large mould according to claim 1, wherein in Step 4, the moving positions of the two adjacent heavy-duty guided vehicles (3) are repeated by 10 cm-15 cm.

5. The mobile quick adhesive dispensing method for a wind turbine blade moulded by a large mould according to claim 1, wherein in Step 4, an adhesive output volume of the high-capacity adhesive mixer (4) is 10 L/min-20 L/min.

6. The mobile quick adhesive dispensing method for a wind turbine blade moulded by a large mould according to claim 1, wherein the screw lift (1) comprises the guided vehicle bearing platform (101), the self-locking screws (102), the frame mechanisms (103), the driving motors (104), speed reducers (105), linear guide pillars (106) and a base plate (107);
the two frame mechanisms (103) arranged oppositely are respectively and perpendicularly installed on the base plate (107), the self-locking screws (102) are fastened on the frame mechanisms (103), the linear guide pillars (106) that are located on both sides of the self-locking screws (102) and arranged parallel to the self-locking screws (102) are fastened to the frame mechanisms (103) respectively, both sides of the guided vehicle bearing platform (101) horizontally installed above the base plate (107) are respectively clamped onto the two opposite frame mechanisms (103), and output ends of the speed reducers (105) secured on the base plate (107) are connected to the self-locking screws (102);
internal threads on the guided vehicle bearing platform (101) are connected with external threads of the self-locking screws (102) in a matched mode, and the linear guide pillars (106) arranged oppositely are respectively clamped on side faces of the guided vehicle bearing platform (101); and
the guided vehicle bearing platform (101) moves up and down within the two frame mechanisms (103) under rotation of the self-locking screws (102).

7. The mobile quick adhesive dispensing method for a wind turbine blade moulded by a large mould according to claim 6, wherein the two self-locking screws (102) arranged oppositely are respectively fastened on the frame mechanisms (103).

8. The mobile quick adhesive dispensing method for a wind turbine blade moulded by a large mould according to claim 1, wherein the heavy-duty guided vehicle (3) comprises the vehicle driving motor (34) installed under a vehicle body (35), and follower wheels (31), limit wheels (32) and driving wheels (33) which are all arranged in pairs, the vehicle driving motor (34) is connected to the driving wheels (33), and the limit wheels (32) fastened below the vehicle body (35) are clamped in grooves in side faces of the high-capacity adhesive mixer rail system (5) to limit the position of the heavy-duty guided vehicle (3) relative to the high-capacity adhesive mixer rail system (5) in a horizontal direction and a width direction.

9. The mobile quick adhesive dispensing method for a wind turbine blade moulded by a large mould according to claim 1, wherein the receding device (6) is hinged between the two adjacent high-capacity adhesive mixer rail systems (5).

10. The mobile quick adhesive dispensing method for a wind turbine blade moulded by a large mould according to claim 9, wherein the receding device (6) comprises a Left receding mechanism (603) and a Right receding mechanism (604) which are respectively hinged to the high-capacity adhesive mixer rail systems (5) through receding hinges (601), and a left air cylinder (602) and a right air cylinder (605) which are used for controlling the Left receding mechanism (603) and the Right receding mechanism (604) to be connected and disconnected, and the left air cylinder (602) and the right air cylinder (605) are connected to air pumps.
